(19) United States
(12) Patent Application Publication
(10) Pub. No.: US 2013/0239032 A1
(43) Pub. Date: Sep. 12, 2013

(54) MOTION BASED SCREEN CONTROL METHOD IN A MOBILE TERMINAL AND MOBILE TERMINAL FOR THE SAME

(71) Applicant: SAMSUNG ELECTRONICS CO., LTD., Gyeonggi-do (KR)

(72) Inventor: Hyun-Su HONG, Gyeonggi-do (KR)

(73) Assignee: Samsung Electronics Co., Ltd., Gyeonggi-do (KR)

(21) Appl. No.: 13/782,551

(22) Filed: Mar. 1, 2013

(30) Foreign Application Priority Data
Mar. 9, 2012 (KR) 10-2012-0024541

(51) Int. Cl. G06F 3/0481

(52) U.S. Cl. CPC G06F 3/0481
USPC 715/765

(57) ABSTRACT

A motion based screen control method which can easily enlarge or reduce an image of a mobile terminal is provided. The method includes determining whether to enlarge or reduce an image within an image viewer screen by detecting a double tap touch input from a user when an image viewer function is performed; and controlling to gradually enlarge or reduce the image according to a degree of a motion of the mobile terminal or a direction of the motion while a touch input is maintained. Thus, the user may control the screen to enlarge or reduce the image to a desired size while the user holds the mobile terminal in one hand.

### PRIORITY

This application claims priority under 35 U.S.C. §119(a) to Korean Patent Application Serial No. 10-2012-0024541, which was filed in the Korean Intellectual Property Office on Mar. 9, 2012, the entire content of which is hereby incorporated by reference.

### BACKGROUND OF THE INVENTION

1. Field of the Invention

The present invention relates generally to a motion based screen control method in a mobile terminal and a mobile terminal for the same, and more particularly, to a method of enlarging or reducing a screen according to a motion in a mobile terminal and a mobile terminal for the same.

2. Description of the Related Art

Recently, due to the rapid development of communication technology, various user interfaces (UI) and various functions using the same have been provided accordingly. Also, in the mobile terminal, various input methods for controlling various functions are now provided.

Among these, a user-friendly user interface is implemented by recognizing an input gesture using a finger/touch pen. Currently, a user interface for performing an operation according to a single-finger based single touch input as well as a user interface for performing an operation according to a multi-finger based multi-touch input have been implemented.

Such a touch screen has a structure in which a surface for sensing an input and a surface for serving as an output display are overlapped with each other. Therefore, the touch screen may analyze and recognize a user's intended input based on a multi touch and output a result thereof. For example, when a user wants to enlarge and view a picture stored in a picture folder in the mobile terminal, the user taps or touches a screen displayed on the touch screen and spreads his/her fingers apart in left and right directions to enlarge or reduce the screen.

In the above case, when a specific part of a touch screen needs to be enlarged or reduced, a ratio at which to enlarge or reduce the screen is controlled by pressing a preset enlarge or reduce key or through a multi touch input. However, when enlarging or reducing the screen by spreading fingers apart in left and right directions, an extent to which the fingers can be spread apart is limited. Therefore, it is difficult to perform a user's desired operation promptly and accurately only with an input on the touch screen and a gesture of spreading the fingers. Moreover, in an existing touch screen, the screen can only be switched to a maximum size or a basic screen view through a double tap touch input, and a separate touch item needs to be selected in order to adjust the screen to a desired enlargement ratio.

### SUMMARY OF THE INVENTION

Accordingly, the present invention has been made to overcome the above problems and/or disadvantages, and to provide the advantages below. Therefore, the present invention provides a motion based screen control method and a mobile terminal for the same, in which a screen of a mobile terminal may be conveniently and easily enlarged or reduced.

In accordance with an aspect of the present invention, a mobile terminal for a motion based screen control is provided. The mobile terminal includes a touch interface for displaying an image on a screen and detecting a touch input according to a touch by a user input means on the screen; a sensor unit for detecting a motion of the mobile terminal; and a controller for determining whether to enlarge or reduce the image according to the touch input and for controlling, when the motion is detected through the sensor unit in a state where the touch input is maintained, to enlarge or reduce the image corresponding to the motion.

In accordance with another aspect of the present invention, a motion based screen control method in a mobile terminal is provided. The motion based screen control method includes displaying an image on a screen; detecting a touch input according to a touch by a user input means on the screen; determining whether a motion of the mobile terminal exists in a state where the touch input is maintained; and enlarging or reducing the image to be displayed corresponding to the motion.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram of a mobile terminal according to an embodiment of the present invention;

FIG. 2 illustrates a double tap touch input according to an embodiment of the present invention;

FIG. 3 is a screen example for explaining a screen enlargement or reduction according to an embodiment of the present invention; and

FIG. 4 is a flow chart of a method for a mobile terminal for motion-based screen enlargement or reduction according to an embodiment of the present invention.

### DETAILED DESCRIPTION OF EMBODIMENTS OF THE PRESENT INVENTION

Hereinafter, various embodiments of the present invention will be described with reference to the accompanying drawings. Particular items such as specific elements found in the following description are provided only to help general understanding of the present invention, and it will be apparent to those skilled in the art that these particular items can be varied or modified within the scope of the present invention.

The present invention implements a method of easily enlarging or reducing an image of a mobile terminal. To this end, a method according to an embodiment of the present invention includes determining whether to enlarge or reduce an image within an image viewer screen when an image viewer function is performed by detecting a double tap touch input from a user, and controlling to gradually enlarge or reduce the image according to a degree of a motion of the mobile terminal or a direction of the motion while a touch input is maintained. In this manner, the user may control the screen to enlarge or reduce to a desired size while the user holds the mobile terminal in one hand.

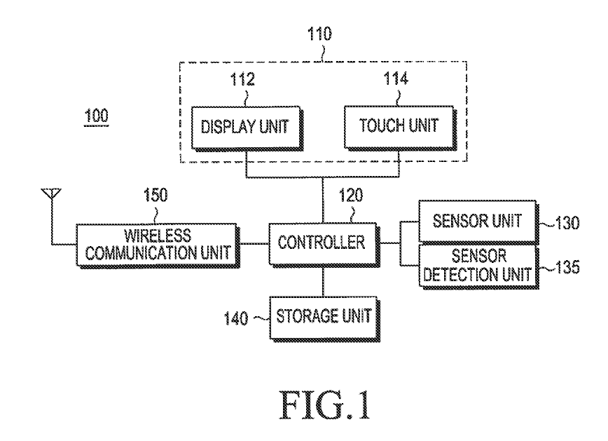

An operation and an element of the mobile terminal which implements the above described function will be described with reference to FIG. 1. Here, the mobile terminal corresponds to apparatuses which support a function of storing and viewing a plurality of images such as a smart phone, a portable phone, a tablet personal computer (PC), a digital camera, an MP3 player, a game player, and a display apparatus, and when images are displayed on a TV, a remote controller which sends a control signal to the TV may correspond to such an apparatus.

FIG. 1 is a block diagram of a mobile terminal according to an embodiment of the present invention. Referring to FIG. 1, a mobile terminal 100 includes a touch interface 110 including a display unit 112 and a touch unit 114, a controller 120, a sensor unit 130, a sensor detection unit 135, a storage unit 140, and a wireless communication unit 150. The touch interface 110 may be referred to as a touch screen and the touch unit 114 may be referred to as a touch panel. In the present example, the mobile terminal having a communication function is shown; however, the present invention may apply to a certain terminal that does not have the communication function. For example, the present invention may similarly apply to a case of enlarging or reducing a TV screen with a remote controller on which the touch interface and the sensor unit are mounted.

The display unit 112 displays at least one image and the display unit 112 may include a Plasma Display Panel (PDP), a Liquid Crystal Display (LCD), an Organic Light Emitting Diodes (OLED), a Light Emitting Diode (LED), etc. In an embodiment of the present invention, the screen is enlarged or reduced according to a motion of the mobile terminal 100; however, it should be noted that it is an image within the screen that is enlarged or reduced.

The touch unit 114 is disposed on the display unit 112 and the user touches various executable items displayed on a surface of the touch interface 110 (i.e., a surface of the touch unit 114) by using a user input means to execute an application or a link page which is related to the item. The touch unit 114 is disposed on an entire surface of the mobile terminal 100 and the display unit 112 is disposed below the touch unit 114. An image generated by the display unit 112 is shown to the user through the transparent touch unit 114. In the present invention, the executable item includes at least an icon, a picture, a menu, and a link (displayed in a text, for example) on a web page.

The controller 120 is a central processing apparatus and controls an overall operation of the mobile terminal 100.

The sensor unit 130 is a sensor for detecting a location, an orientation, and a motion of the mobile terminal 100 and may be implemented in an inertia sensor such as an accelerometer, a gyroscope, a shock sensor, a tilt sensor, an altimeter, a gravity sensor, an electromagnetic sensor, or a combination thereof. It should be noted that the present invention is not limited thereto, and the sensor unit 130 may be implemented in another type of a sensor which can detect a direction of the motion or a tilt of the mobile terminal 100.

The sensor detection unit 135 monitors the sensor unit 130 to determine a signal generated in the sensor unit 130. Specifically, the sensor detection unit 135 distinguishes an operation of tilting the mobile terminal 100, an operation of pulling the mobile terminal 100 in a horizontal direction toward the user relative to the user, and an operation of pushing the mobile terminal 100 away from the user in the horizontal direction, and transmits a corresponding operation signal to the controller 120.

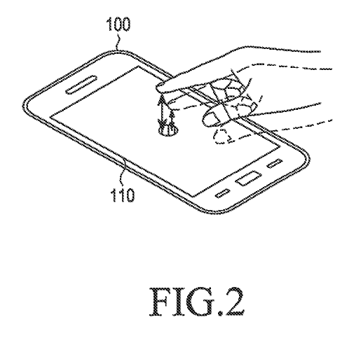

Accordingly, the display unit 112 outputs an image that needs to be enlarged or reduced according to a user's request under control of the controller 120 and, as shown in FIG. 2, the image within the screen is output in a maximum enlarged size or a basic size according to the double tap touch input. Referring to FIG. 2, when the user performs a double tap touch or a triple tap touch by a finger, as an example of the user input means, on the touch interface 110, the image within the screen is enlarged or reduced to a designated size. Here, in a state in which a double tap touch operation is maintained, i.e., the user does not remove the finger from the screen but maintains the finger on the screen and an operation signal for tilting, pushing or pulling the mobile terminal 100 is input from the sensor detection unit 135, the controller 120 may output an enlarged or reduced image through the display unit 112.

The storage unit 140 stores an operating system of the mobile terminal 100, various applications, information input to the mobile terminal 100, and information generated therein. For example, the storage unit 140 stores an image such as a picture and stores information about mapping between a rate of motion change, e.g., a movement travel distance or a tilt angle, and a screen enlargement ratio or a screen reduction ratio corresponding thereto. A non-volatile memory may be used for the storage unit 140.

The wireless communication unit 150 wirelessly transmits data from the controller 120 or wirelessly receives data over the air to be transmitted to the controller 120.

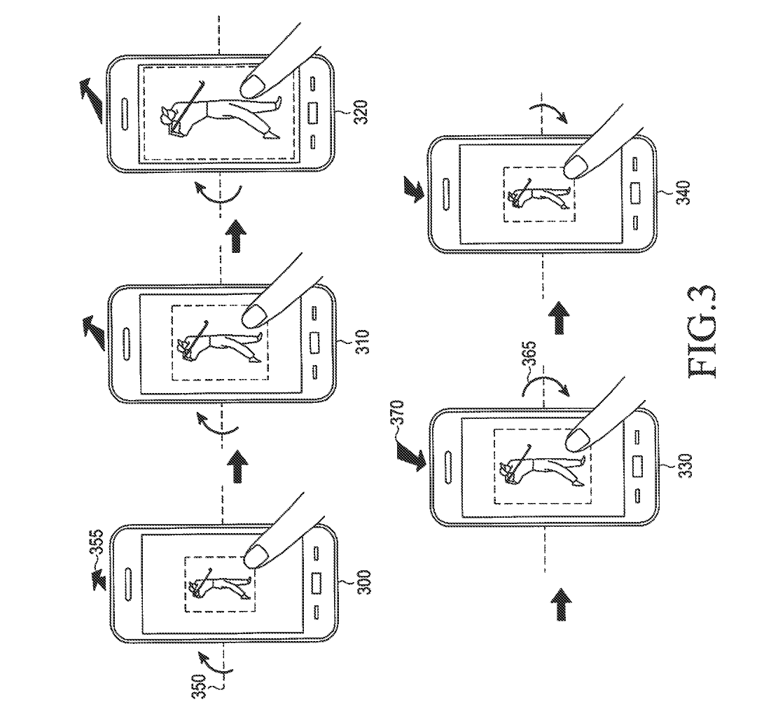

FIG. 3 is a screen example for explaining a screen enlargement or reduction according to an embodiment of the present invention. Referring to FIG. 3, when a user executes an image viewer application for outputting an image of a picture and a web page, a screen as identified by reference number 300 is output. The image is stored in the storage unit 140 of the mobile terminal and a terminal having a wireless internet capability executes the web page without a need for executing the image viewer in order to view a pre-stored web page image. When such a screen is output and the user inputs a single touch, items related to the image viewer application are generally displayed. However, in order for the user to enlarge and view a desired part of the image, the double tap touch input needs to be input. Such a double tap touch input may be entered by using one finger or two or more fingers.

Therefore, when the image viewer screen such as the screen identified by reference 300 is output, the user determines a reference point of a part to be enlarged or reduced through the double tap touch input. Next, when the user performs a motion of tilting the mobile terminal 100 rearward such as in a direction 350 or performs a motion of pushing the mobile terminal 100 such as in a direction 355 while maintaining the touch input, an image enlarged in a ratio corresponding to a tilt degree or a travel distance according to the pushing motion with respect to the reference point as in a screen identified by reference number 310 is output to an image view screen. When the mobile terminal 100 is tilted at a predetermined angle or more or pushed, an enlarged image is output to the screen, as shown in reference number 320. Here, the enlarged image may correspond to an entire image, however, it is preferable to enlarge a part relative to the reference point.

To the contrary, when the user performs a motion of pulling the mobile terminal 100 such as in a direction 370 or tilts the mobile terminal 100 forward such as in a direction 365 while maintaining the touch input in a screen identified by reference number 330, an image reduced relative to the reference point as shown in a screen identified by reference number 340 is output. Thus, when the user enters the double tap touch input and performs the motion of tilting the mobile terminal 100 forward or rearward or pulling or pushing the mobile terminal 100 forward or backward while maintaining the touch input, an image enlarged or reduced in a ratio according to the tilt degree or the travel distance is output.

In a state where the image is enlarged or reduced, if the user discontinues a touch or stops the tilting motion to switch the mobile terminal 100 to a balanced state, the mobile terminal 100 stops an operation of enlarging or reducing the image. According to such a stop, the enlarged or reduced image at a time point of the stop is displayed. Also, a function of enlarging the image when the mobile terminal 100 is pushed and reducing the image when the mobile terminal 100 is pulled can be modified according to user setting. For example, the function may be modified such that the image may be reduced when the mobile terminal 100 is pushed and the image may be enlarged when the mobile terminal 100 is pulled.

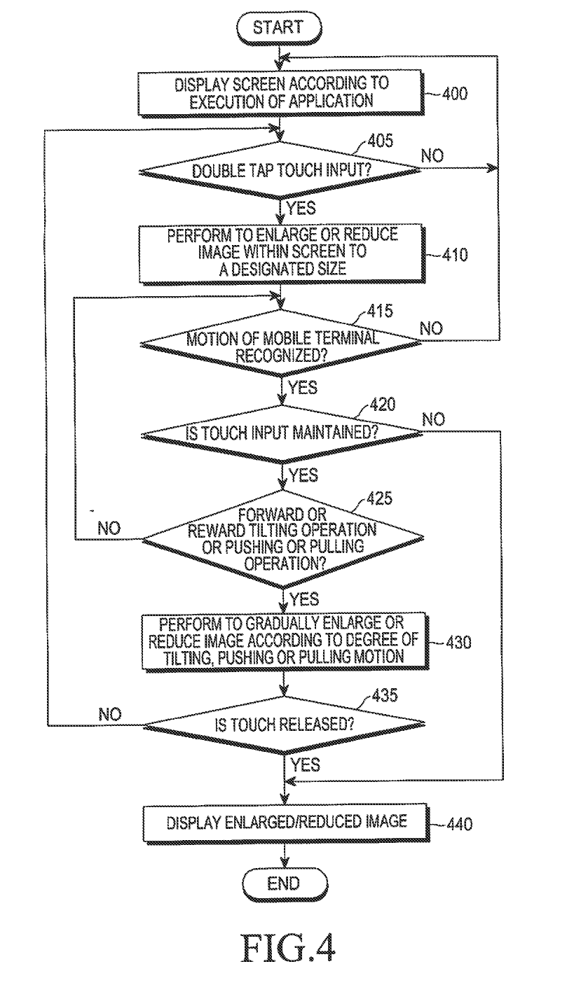

Hereinafter, a process of a motion based operation of the mobile terminal for enlarging or reducing a screen according to an embodiment of the present invention will be described with reference to FIG. 4.

Referring to FIG. 4, the mobile terminal 100 displays a screen according to an execution of the application in step 400. Here, the executed application may be any application which outputs an image to the screen that can be enlarged or reduced. In a state where such a screen is displayed, if the double tap touch input is received in step 405, the mobile terminal 100 performs a function to enlarge or reduce the image to a designated size in step 410. In other words, the image is enlarged to a maximum size within the screen, or reduced accordingly.

In this condition, the mobile terminal 100 determines whether a motion of the terminal is recognized in step 415. If the terminal motion is recognized, it is determined whether the touch input is maintained in step 420. To the contrary, if the terminal motion is not recognized in step 415, the method returns to step 400.

Furthermore, when the touch input is not maintained in step 420, i.e., when the touch is released, the method proceeds to step 440, and the enlarged or reduced image is displayed. To the contrary, when the touch input is maintained in step 420, whether the recognized motion corresponds to one of a forward or rearward tilting motion or a pushing or pulling motion is determined in step 425. When the recognized motion does not correspond to any of the forward or rearward tilting motion or the pushing or pulling motion in step 425, the method returns to step 415 to determine whether the terminal motion is recognized.

When the recognized motion corresponds to one of the forward or rearward tilting motion or the pushing or pulling motion in step 425, the mobile terminal 100 performs a function to enlarge or reduce the screen, i.e., the image within the screen gradually enlarged or reduced according to a degree of the tilting or pushing or pulling motion, in step 430. Here, the degree of the pushing or pulling motion refers to a travel distance in a horizontal direction. In this case, when the user enters the double tap touch input at a specific point by using a finger, the image is enlarged to the maximum size relative to the touch input point, and the user may control an enlargement ratio as desired by the tilting, pushing or pulling motion without removing the finger.

Next, if the user maintains the touch input in step 435, i.e. the touch input is not released, the mobile terminal 100 returns to step 405 to repeat the above described process, unless the touch input is released in step 435. When the touch is maintained and the mobile terminal 100 returns to step 405, the mobile terminal 100 may return to an original image of a preset size when the double tap touch input is again entered. In other words, the image is output in its basic or original size. In this state, a screen size may be controlled to a desired ratio by the tilting, pushing, or pulling motion without releasing the finger. Meanwhile, when the touch input is released in step 435, the enlarged or reduced image at a time point at which the touch is released is output in step 440. In other words, when the user releases the finger from the screen in a state where the enlarged or reduced screen is output, the operation of the enlarging/reducing the image is stopped.

According to the present invention, a user interface having an easy and convenient function of enlarging or reducing the screen of the mobile terminal is provided. Also, the function of enlarging or reducing the screen based on a motion according to the present invention enables the user to easily control the screen to a desired size according to a combination of a touch and the motion, while the user holds the mobile terminal in one hand. Due to such an advantage, the present invention is suitable for application to a remote controller device for a TV or a personal computer (PC), which is usually used by a user with one hand. Also, by providing an expanded type of interface while maintaining an existing touch interface, the user may selectively use a screen enlarging or reducing control mode according to user preference and portability conditions.

It should be noted that the embodiments of the present invention may be implemented by hardware, software, or any combination thereof. Such software may be stored, regardless of whether data can be deleted or re-written, in a volatile or non-volatile storage device such as a read-only memory (ROM), or a random access memory (RAM), a memory chip, or a memory such as a device or an integrated circuit, or a machine readable storage device, while being capable of recording optically or magnetically at the same time, such as, for example, a compact disk (CD), a DVD, a magnetic disk, or a magnetic tape. It should be understood that the storage unit is an example of a machine readable storage medium suitable for storing a program or programs including instructions implementing the embodiments of the present invention. Therefore, the present invention includes a program including codes for implementing a method in the appended claims of the present invention and a machine readable storage medium for storing the program. Also, such a program may be electrically transmitted through any medium similar to a communication signal which is propagated by wire or wirelessly, and the present invention appropriately includes equivalents thereof.

Also, the mobile terminal may receive and store the program from a program providing apparatus by wire or wirelessly connected thereto. The program providing apparatus may include a program including instructions for the mobile terminal to perform a preset motion based screen control method, a memory for storing information needed for motion based screen control, a communication unit for performing wired or wireless communication with the mobile terminal, and a controller for transmitting a corresponding program to the mobile terminal automatically or in response to a request from the mobile terminal.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A mobile terminal for a motion based screen control, the mobile terminal comprising:
a touch interface for displaying an image on a screen and detecting a touch input according to a touch by a user input means on the screen;
a sensor unit for detecting a motion of the mobile terminal; and
a controller for determining whether to enlarge or reduce the image according to the touch input and for controlling, when the motion is detected through the sensor unit in a state where the touch input is maintained, to enlarge or reduce the image corresponding to the motion.

2. The mobile terminal of claim 1, wherein the touch input is a double tap touch input.

3. The mobile terminal of claim 1, further comprising:
a sensor detection unit for monitoring the sensor unit to determine, based on a signal generated in the sensor unit, whether the motion corresponds to one of a forward tilting operation of the mobile terminal, a rearward tilting operation of the mobile terminal, an operation of pulling the mobile terminal toward a user, relative to the user, in a horizontal direction, or an operation of pushing the mobile terminal away from the user in the horizontal direction.

4. The mobile terminal of claim 3, wherein the controller controls to gradually enlarge or reduce the image relative to a point at which the touch input is generated according to the forward or rearward tilting operation determined by the sensor detection unit.

5. The mobile terminal of claim 3, wherein the controller controls to gradually enlarge or reduce the image relative to a point at which the touch input is generated according to the pushing or pulling operation determined by the sensor detection unit.

6. The mobile terminal of claim 1, wherein, when the touch is released, the controller controls to display the enlarged or reduced image on the touch interface at a time point at which the touch is released.

7. The mobile terminal of claim 1, wherein the controller enlarges the image in to maximum size according to the touch input and, when the touch input is released and then the touch input is again received, controls the enlarged image to return to a basic size.

8. A motion based screen control method in a mobile terminal, the motion based screen control method comprising:
displaying an image on a screen;
detecting a touch input according to a touch by a user input means on the screen;
determining whether a motion of the mobile terminal exists in a state where the touch input is maintained; and
enlarging or reducing the image to be displayed corresponding to the motion.

9. The motion based screen control method of claim 8, wherein the touch input is a double tap touch input.

10. The motion based screen control method of claim 8, wherein the motion is one of a forward tilting operation of the mobile terminal, a rearward tilting operation of the mobile terminal, an operation of pulling the mobile terminal toward a user, relative to the user, in a horizontal direction, or an operation of pushing the mobile terminal away from the user in the horizontal direction.

11. The motion based screen control method of claim 10, wherein displaying the image comprises:
gradually enlarging or reducing the image relative to a point at which the touch input is generated according to the forward tilting operation of the mobile terminal or the rearward tilting operation of the mobile terminal and displaying the enlarged or reduced image.

12. The motion based screen control method of claim 10, wherein displaying the image comprises:
gradually enlarging or reducing the image relative to a point at which the touch input is generated according to the pushing or pulling operation and displaying the enlarged or reduced image.

13. The motion based screen method of claim 8, further comprising:
when the touch is released, displaying the enlarged or reduced image on the touch interface at a time point at which the touch is released.

14. The motion based screen method of claim 8, further comprising:
enlarging the image to a maximum size according to the touch input and, when the touch input is released and then the touch input is again received, restoring the enlarged image to a basic size.

15. A machine readable storage medium which records thereon a program for executing the motion based screen control method, the method comprising.
displaying an image on a screen;
detecting a touch input according to a touch by a user input means on the screen;
determining whether a motion of the mobile terminal exists in a state where the touch input is maintained; and
enlarging or reducing the image to be displayed corresponding to the motion.
